(19) United States
(12) Patent Application Publication
(10) Pub. No.: US 2020/0074324 A1
(43) Pub. Date: Mar. 5, 2020

(54) NOISE CONTRASTIVE ESTIMATION FOR COLLABORATIVE FILTERING

(71) Applicant: THE TORONTO-DOMINION BANK, Toronto (CA)

(72) Inventors: Ga Wu, TORONTO (CA); Maksims Volkovs, TORONTO (CA); Himanshu Rai, TORONTO (CA)

(21) Appl. No.: 16/546,134

(22) Filed: Aug. 20, 2019

Related U.S. Application Data
(60) Provisional application No. 62/726,958, filed on Sep. 4, 2018.
(60) Provisional application No. 62/741,694, filed on Oct. 5, 2018.

(51) Int. Cl. G06N 5/04; G06F 17/16

(52) U.S. Cl. CPC G06N 5/04; G06F 17/16

(57) ABSTRACT

A recommendation system models unknown preferences as samples from a noise distribution to generate recommendations for an online system. Specifically, the recommendation system obtains latent user and item representations from preference information that are representations of users and items in a lower-dimensional latent space. A recommendation for a user and item with an unknown preference can be generated by combining the latent representation for the user with the latent representation for the item. The latent user and item representations are learned to discriminate between observed interactions and unobserved noise samples in the preference information by increasing estimated predictions for known preferences in the ratings matrix, and decreasing estimated predictions for unobserved preferences sampled from the noise distribution.

### CROSS-REFERENCE TO RELATED APPLICATIONS

This application claims the benefit of U.S. Provisional Patent Application No. 62/726,958, filed on Sep. 4, 2018, and U.S. Provisional Patent Application No. 62/741,694, filed on Oct. 5, 2018, each of which is hereby incorporated by reference in its entirety.

### BACKGROUND

This disclosure relates generally to generating recommendations, and more particularly to generating recommendations for users of online systems.

Online systems manage and provide various items to users of the online systems for users to interact with. As users interact with the content items, users may express or reveal preferences for some items over others. The items may be entertainment content items, such as videos, music, or books, or other types of content, such as academic papers, electronic commerce (e-commerce) products. It is advantageous for many online systems to include recommendation systems that suggest relevant items to users for consideration.

Recommendation systems can increase frequency and quality of user interaction with the online system by suggesting content a user is likely to be interested in or will interact with. For example, a recommendation system included in a video streaming server may identify and suggest movies that a user may like based on movies that the user has previously viewed.

In general, models for recommendation systems use preference information between users and items of an online system to predict whether a particular user will like a particular item, such as an item that the user has not previously rated. The preference information may be represented in the form of a ratings matrix that represents a plurality of ratings between users and items. Items that are predicted to have high preference for the user may then be suggested to the user for consideration. The preference information contains information on users' partial or full interactions with items of the online system, but may include a significantly large number of users and items with unknown preferences. For example, the preference information may be limited to items that the users have high preference for because the online system only receives feedback through interactions between users and items that users like. Thus, a large number of elements may be unknown simply because the users were not aware of the presented items, or the users disliked these items but such negative feedback could not be recorded through the online system.

Typically, in the absence of explicit negative preferences, conventional recommendation systems generate recommendations by explicitly or implicitly assuming that unknown preferences are negative signals due to their representation in the ratings matrix. This assumption makes recommendations highly biased to the large amount of unknown data, which can result in poor prediction accuracy especially for less popular items. Predictions may be skewed by popular items, causing recommendation systems to over- or under-recommend content items that have more or fewer total evaluations. Thus, recommendation systems need to generate effective recommendations for both existing and new users and items while relying on incomplete or absent preference information.

### SUMMARY

A recommendation system models unknown preferences as samples from a noise distribution to generate recommendations for an online system. Specifically, the recommendation system obtains latent user and item representations from preference information that are representations of users and items in a lower-dimensional latent space. A recommendation for a user and item with an unknown preference can be generated by combining the latent representation for the user with the latent representation for the item. The latent user and item representations are learned to discriminate between observed interactions and unobserved noise samples in the preference information by increasing estimated predictions for known preferences in the ratings matrix, and decreasing estimated predictions for unobserved preferences sampled from the noise distribution.

In one embodiment, the noise distribution is a popularity-based item distribution, in which items that have a higher number of users who interacted with the item are more likely to be sampled. Popular items are more likely to be encountered by users of the online system, so the absence of a positive interaction with these items are more likely to be indicative of negative feedback. By modeling unobserved preferences using a popularity-based noise distribution, recommendations can be made more uniformly across items with varying popularity, without explicitly assuming that unknown preferences indicate dislike. In other words, a higher emphasis can be placed on accurate predictions for less popular items.

Specifically, the recommendation system obtains latent user and item representations from a depopularized matrix that attempts to remove the effects of content item frequency (i.e., popularity) in the ratings matrix to de-emphasize popular items. The depopularized matrix includes a set of scaled ratings that are generated by scaling the ratings in the ratings matrix by decreasing a rating for a user and an item based on the number of users who interacted with the item. Stated another way, the ratings matrix is modified to reduce the effect of content items that are highly popular to reduce the likelihood that these items are recommended at a higher frequency than they actually appear in the ratings matrix. A recommendation for a user and item with an unknown preference can be generated by combining (e.g., as a dot product) the latent representation for the user with the latent representation for the item.

In one embodiment, instead of combining latent user and item representations to generate recommendations, a recommendation for a user and item can be generated by combining a dynamic user representation for the user with a set of learned projected item weights for the item. The dynamic user representation for a user is determined by combining (e.g., averaging) the latent item representations of items the user has interacted with. The set of projected item weights for each item may be learned by reducing a loss function. For one or more known elements in the ratings matrix, the loss function indicates a difference between the actual rating for the user-item pair and an estimated prediction for the element that is generated by combining the dynamic user representation for the user with an estimated set of projected item weights for the item.

In this approach, users may be dynamically represented based on ratings, permitting new users and existing users to be dynamically represented to account for changing user ratings without re-training the latent content representations. Moreover, since the dimensionality of the latent space is significantly smaller than the number of users and items, the importance of latent features can be learned in a computationally efficient manner, and can be easily scaled with the number of users and items.

### BRIEF DESCRIPTION OF DRAWINGS

FIG. 1 is a high-level block diagram of a system environment for a recommendation system, in accordance with an embodiment.

FIG. 2 illustrates an example ratings matrix for a video streaming system, in accordance with an embodiment.

FIG. 3 illustrates an example process for generating latent user representations and latent item representations from a depopularized matrix, in accordance with an embodiment.

FIG. 4 is an example block diagram of an architecture of the recommendation system 130, in accordance with an embodiment.

FIG. 5 illustrates an example latent user representation matrix and an example latent item representation matrix obtained from the depopularized matrix in FIG. 3, in accordance with an embodiment.

FIG. 6A illustrates a method of generating rating predictions for a set of users and a set of items of an online system, in accordance with an embodiment.

FIG. 6B illustrates a method of training projected item weights from latent user and item representations, in accordance with an embodiment.

FIGS. 7A through 7C illustrate performance results of example recommendation models presented herein in comparison to other state-of-the-art models, in accordance with an embodiment.

FIG. 8 illustrates the training time for example recommendation models presented herein in comparison to other state-of-the-art models, in accordance with an embodiment.

The figures depict various embodiments of the present invention for purposes of illustration only. One skilled in the art will readily recognize from the following discussion that alternative embodiments of the structures and methods illustrated herein may be employed without departing from the principles described herein.

### DETAILED DESCRIPTION

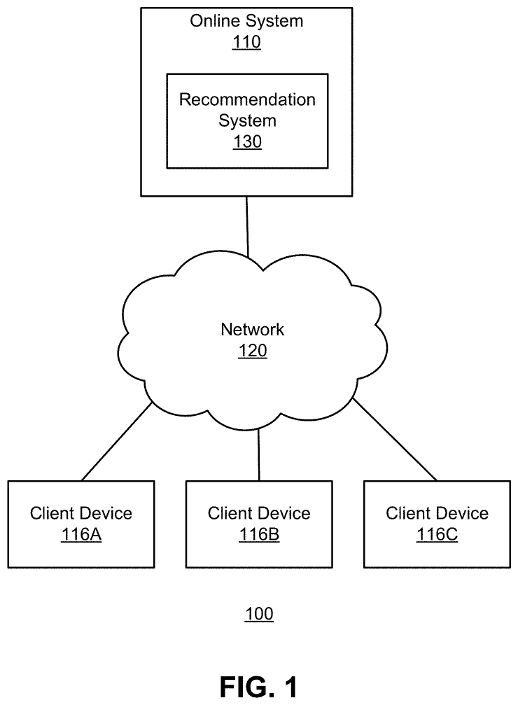

FIG. 1 is a high-level block diagram of a system environment for a recommendation system 130, in accordance with an embodiment. The system environment 100 shown by FIG. 1 includes one or more client devices 116, a network 120, and an online system 110 that includes a recommendation system 130. In alternative configurations, different and/or additional components may be included in the system environment 100.

The online system 110 manages and provides various items to users of the online systems for users to interact with. For example, the online system 110 may be a video streaming system, in which items are videos that users can upload, share, and stream from the online system 110. As another example, the online system 110 may be an e-commerce system, in which items are products for sale, and sellers and buyers can browse items and perform transactions to purchase products. As another example, the online system 110 may be article directories, in which items are articles from different topics, and users can select and read articles that are of interest.

The recommendation system 130 identifies relevant items that users are likely to be interested in or will interact with and suggests the identified items to users of the online system 110. It is advantageous for many online systems 110 to suggest relevant items to users because this can lead to increase in frequency and quality of interactions between users and the online system 110, and help users identify more relevant items. For example, a recommendation system 130 included in a video streaming server may identify and suggest movies that a user may like based on movies that the user has previously viewed. Specifically, the recommendation system 130 may identify such relevant items based on preference information received from users as they interact with the online system 110.

The preference information contains preferences for some items by a user over relative to other items. The preference information may be explicitly given by users, for example, through a rating survey that the recommendation system 130 provides to users, and/or may be deduced or inferred by the recommendation system 130 from actions of the user. Depending on the implementation, inferred preferences may be derived from many types of actions, such as those representing a user's partial or full interaction with a content item (e.g., consuming the whole item or only a portion), or a user's action taken with respect to the content item (e.g., sharing the item with another user or favorable mention of the item in a post). The recommendation system 130 uses models to predict whether a particular user will like an item based on preference information. Items that are predicted to have high preference by the user may then be suggested to the user for consideration.

In one embodiment, the recommendation system 130 represents preference information in the form of a ratings matrix that represents a plurality of ratings between the set of users and the set of items. An element in the ratings matrix for a user and an item indicates a preference of the user for the item that is explicitly or implicitly inferred from the user's interaction with the item. In a typical example described herein, each element in the ratings matrix corresponds to a rating value that numerically indicates the preference of a user for an item based on a predetermined scale. For example, an element in the rating matrix may be a Boolean value of zero or one, in which a one represents a preference or an interaction of a user with a content item, and a value of zero represents no preference or an unknown preference with the item. A prediction of a user and an item with an unknown preference may indicate a likelihood that the user will interact with the item. Thus, a higher prediction may indicate a higher likelihood that the user will interact with the item.

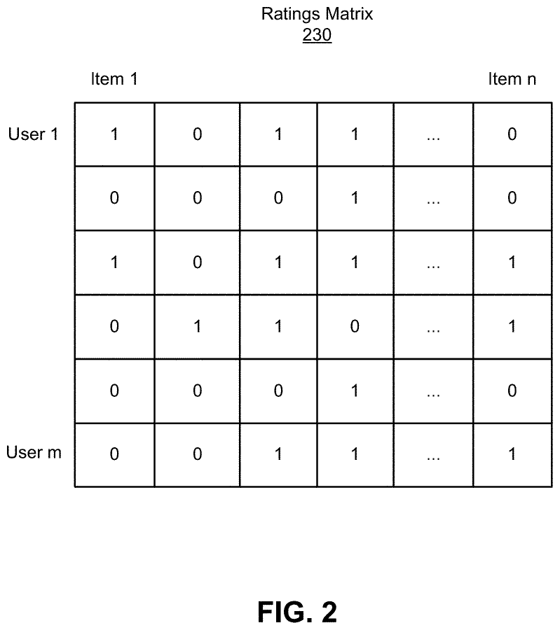

FIG. 2 illustrates an example ratings matrix 230 for a video streaming system, in accordance with an embodiment. The ratings matrix 230 is associated with a set of n users and a set of m video items of the online system 110. Each row corresponds to a user i=1, 2, . . . , n, and each column corresponds to an item j=1, 2, . . . , m. An element in the ratings matrix 230 for a user u and a video item v is a Boolean rating value, in which one represents a preference or an interaction of a user with a video item, and a zero represents either no preference or an unknown preference with the video item. For example, the element for user 1 and item 1 indicates that user 1 has a preference for item 1, while the element for user 1 and item n indicates that user 1 had no preference or an unknown preference for item n. The recommendation system 130 may analyze the preference information contained in the ratings matrix 230 to generate predictions for user-items with unknown preferences to predict whether users will interact with these items, such that appropriate recommendations can be made to users.

The recommendation system 130 may have millions of users and items of the online system 110 for which to generate recommendations and expected user preferences and may also receive new users and items for which to generate recommendations. Preference information may be significantly sparse because of the very large number of content items, and may include many user-item pairs with unknown preferences. For example, the preference information may be limited to items that the users have high preference for because the online system 110 only receives feedback through interactions between users and items that users like. Thus, a large number of elements may be unknown simply because the users were not aware of the presented items, or the users disliked these items but such negative feedback could not be recorded through the online system 110. The recommendation system 130 generates recommendations for both existing and new users and items based on incomplete or absent preference information for a very large number of the content items.

Typically, in the absence of explicit negative preferences, conventional recommendation systems generate recommendations by explicitly or implicitly assuming that unknown preferences are negative signals (e.g., user “disliked” an item) due to their representation in the ratings matrix. For example, while unknown preferences can be represented as zeros in a ratings matrix with a Boolean representation, these preferences may be regarded as implicitly negative due to the binary nature of representing preferences as zeros and ones in the ratings matrix. This assumption makes recommendations highly biased to the large amount of unknown data, which can result in poor prediction accuracy especially for less popular items. Predictions may be skewed by popular items, causing recommendation systems to over- or under-recommend content items that have more or fewer total evaluations.

In one embodiment, the recommendation system 130 generates recommendations for the online system 110 by modeling unknown preferences in the ratings matrix as samples from a noise distribution to generate recommendations for the online system 110. Specifically, the recommendation system 130 obtains latent user and item representations that are representations of users and items in a lower-dimensional latent space. A recommendation for a user and item with an unknown preference can be generated by combining the latent representation for the user with the latent representation for the item. The latent user and item representations are learned to discriminate between observed interactions and unobserved noise samples in the ratings matrix by increasing estimated predictions for known preferences in the ratings matrix, while decreasing estimated predictions for unobserved preferences sampled from the noise distribution.

In one embodiment, the noise distribution is a popularity-based item distribution, in which items that have a higher number of users who interacted with the item are more likely to be sampled. Popular items are more likely to be encountered by users of the online system, so the absence of a positive interaction with these items are more likely to be indicative of negative feedback. By modeling unobserved preferences using a popularity-based noise distribution, recommendations can be made more uniformly across items with varying popularity, without assuming that unknown preferences are negative signals. In other words, a higher emphasis can be placed on accurate predictions for less popular items.

To do so, the recommendation system 130 obtains latent user and item representations from a depopularized matrix that attempts to remove the effects of content item frequency (i.e., popularity) in the ratings matrix to de-emphasize popular items. The depopularized matrix includes a set of scaled ratings that are generated by scaling the ratings in the ratings matrix. In particular, the scaled ratings are generated by decreasing a rating for a user and an item based on the number of users who interacted with the item. Stated another way, the rating matrix is modified to reduce the effect of content items that are highly popular to reduce the likelihood that these items are recommended at a higher frequency than they actually appear in the ratings matrix.

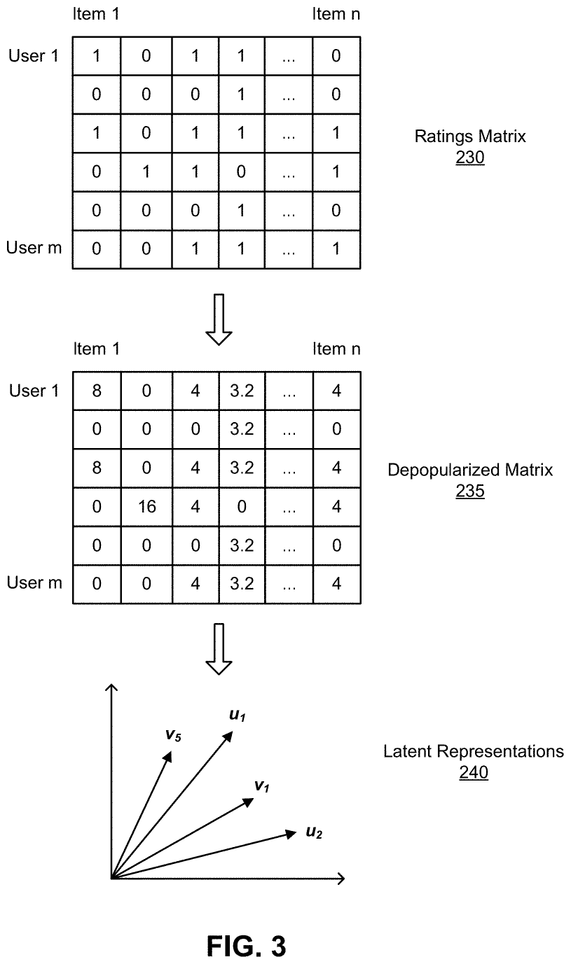

FIG. 3 illustrates an example process for generating latent user representations and latent item representations 240 from a depopularized matrix 235, in accordance with an embodiment. As shown in FIG. 3, the recommendation system 130 obtains a depopularized matrix 235 from the ratings matrix 230. Specifically, the depopularized matrix 235 includes a set of scaled ratings that are generated by scaling the ratings in the ratings matrix 230, such that ratings for popular items are downweighted at a higher degree than less popular items. For example, as shown in FIG. 3, ratings for item 4 are scaled to 3.2 as the most popular item with five user interactions, while ratings for item 2 are scaled to 16 as the least popular item with one user interaction. Thus, popular items in the depopularized matrix may be associated with lower ratings than less popular items.

The recommendation system 130 obtains latent user and item representations 240 from the depopularized matrix 235. As an example, FIG. 3 illustrates latent user representations for user 1 (u₁), user 2 (u₂), item 1 (v₁), and item 5 (v₅) in a low-dimensional latent space with two dimensions. Predictions for unknown user-item preferences can be generated by combining (e.g., dot product) the latent user representation for the user with the latent item representation for the item. For example, the predicted preference between user 1 and item 5 may be determined by taking a dot product between the latent user representation for user 1 (u₁) and latent item representation for item 5 (v₅).

In one embodiment, instead of combining latent user and item representations to generate recommendations, a recommendation for a user and item can be generated by combining a dynamic user representation for the user with a set of learned projected item weights for the item. The dynamic user representation for a user is determined by combining (e.g., averaging) the latent item representations of items the user has interacted with. The set of projected item weights indicate the importance of each latent feature for each item, and may be learned by reducing a loss function. For one or more known elements in the ratings matrix, the loss function indicates a difference between the actual rating for the user-item pair and an estimated prediction for the element that is generated by combining the dynamic user representation for the user with an estimated set of projected item weights for the item.

In this approach, users may be dynamically represented based on ratings, permitting new users and existing users to be dynamically represented to account for changing user ratings without re-training the latent content representations. Moreover, since the dimensionality of the latent space is significantly smaller than the number of users and items, the importance of latent features can be learned in a computationally efficient manner, and can be easily scaled with the number of users and items.

The client devices 116 are computing devices that display information to users and communicates user actions to the online system 110. While three client devices 116A, 116B, 116C are illustrated in FIG. 1, in practice many client devices 116 may communicate with the online system 110 in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120, which may comprise any combination of local area and/or wide area networks, using both wired and/or wireless communication systems.

In one embodiment, a client device 116 executes an application allowing a user of the client device 116 to interact with the online system 110. For example, a client device 116 executes a browser application to enable interaction between the client device 116 and the online system 110 via the network 120. In another embodiment, the client device 116 interacts with the online system 110 through an application programming interface (API) running on a native operating system of the client device 116, such as IOS® or ANDROID™.

The client device 116 allows users to perform various actions on the online system 110, and provides the action information to the recommendation system 130. For example, actions information for a user may include a list of items that the user has previously viewed on the online system 110, search queries that the user has performed on the online system 110, items that the user has uploaded on the online system 110, and the like. Action information may also include information on user actions performed on third party systems. For example, a user may purchase products on a third-party website, and the third-party website may provide the recommendation system 130 with information on which user performed the purchase action.

The client device 116 can also provide social information to the recommendation system 130. For example, the user of a client device 116 may permit the application of the online system 110 to gain access to the user's social network profile information. Social information may include information on how the user is connected to other users on the social networking system, the content of the user's posts on the social networking system, and the like. In addition to action information and social information, the client device 116 can provide other types of information, such as location information as detected by a global positioning system (GPS) on the client device 116, to the recommendation system 130.

In one embodiment, the client devices 116 also allow users to rate items and provide preference information on which items the users prefer over the other. For example, a user of a movie streaming system may complete a rating survey provided by the recommendation system 130 to indicate how much the user liked a movie after viewing the movie. In some embodiments, the ratings may be a zero or a one (indicating interaction or no interaction), although in other embodiments the ratings may vary along a range. For example, the survey may request the user of the client device 116B to indicate the preference using a binary scale of “dislike” and “like,” or a numerical scale of 1 to 5 stars, in which a value of 1 star indicates the user strongly disliked the movie, and a value of 5 stars indicates the user strongly liked the movie. However, many users may rate only a small proportion of items in the online system 110 because, for example, there are many items that the user has not interacted with, or simply because the user chose not to rate items.

Preference information is not necessarily limited to explicit user ratings and may also be included in other types of information, such as action information, provided to the recommendation system 130. For example, a user of an e-commerce system that repeatedly purchases a product of a specific brand indicates that the user strongly prefers the product, even though the user may not have submitted a good rating for the product. As another example, a user of a video streaming system that views a video only for a short amount of time before moving onto the next video indicates that the user was not significantly interested in the video, even though the user may not have submitted a bad rating for the video.

The client devices 116 also receive item recommendations for users that contain items of the online system 110 that users may like or be interested in. The client devices 116 may present recommendations to the user when the user is interacting with the online system 110, as notifications, and the like. For example, video recommendations for a user may be displayed on portions of the website of the online system 110 when the user is interacting with the website via the client device 116. As another example, client devices 116 may notify the user through communication means such as application notifications and text messages as recommendations are received from the recommendation system 130.

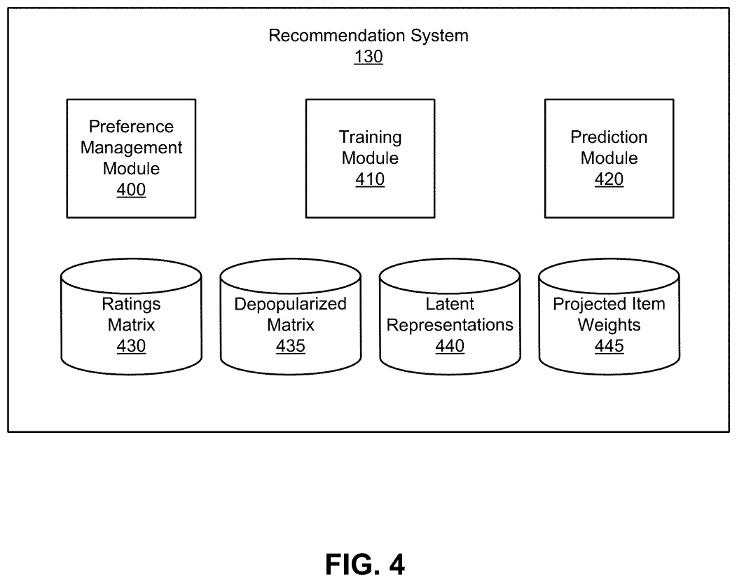

FIG. 4 is an example block diagram of an architecture of the recommendation system 130, in accordance with an embodiment. The recommendation system 130 shown by FIG. 4 includes a preference management module 400, a training module 410, and a prediction module 420. For convenience in illustrating this disclosure, the recommendation system 130 also includes data stores: rating matrix 430, depopularized matrix 435, latent representations 450, and projected item weights 460. In alternative configurations, different and/or additional components may be included in the system environment 100.

The preference management module 400 manages preference information for users of the online system 110. Specifically, the preference management module 400 may manage a set of n users i=1, 2, . . . , n and a set of m items j=1, 2, . . . , m of the online system 110. In one embodiment, the preference management module 400 represents the preference information as a ratings matrix database 430. The ratings matrix database 430 is a matrix array R of elements consisting of n rows and m columns, in which each row u corresponds to user i, and each column v corresponds to item j. Each element R(i,j) corresponds to the rating value that numerically indicates the preference of user u for item v based on a predetermined scale.

The preference management module 400 determines ratings for users and items in the rating matrix 430 from the preference information received from the client devices 116. In one embodiment, the preference management module 400 populates the rating matrix 430 with user preferences that were expressed by the user through interactions with the content items or with rating surveys, and the like. For example, the preference management module 400 may receive user ratings based on a scale of 1 to 5 for a list of movies in the online system 110, and populate the rating matrix 430 with values of the ratings for the corresponding user and movie. These ratings may also be modified to reflect a different rating scale. For example, when the ratings in the matrix are Boolean, the user ratings may be translated to a Boolean value. This may be performed by treating a user value of 1 or 2 as a Boolean “0,” and user values of 3, 4, and 5 as a Boolean “1.”

In another embodiment, when explicit user preferences are unknown, the preference management module 400 determines estimated ratings for the users based on information such action information, and populates the rating matrix 430 with the estimated ratings. For example, the preference management module 400 may populate the ratings matrix 430 with a binary value of 1 for a corresponding user and movie if there is an indication the user views the movie for a repeated number of times, or a binary value of 0 if the user stops viewing the video before the video has finished playing. As another example, the preference management module 400 populates the rating matrix 430 with rankings that represent the order in which a user prefers the set of items in the online system 110. As an alternative, the ratings matrix 430 may be received from an external system to the recommendation system 130 when, for example, the recommendation system 130 is a separate system from the online system 110.

In the typical example herein, the ratings matrix is a Boolean value of zero or one. As discussed in conjunction with FIG. 1, the preference information may be incomplete and limited with respect to the types and ranges of interactions that can be identified and recorded from the preference information. For example, the preference information may contain only a single type (e.g., positive) of interaction between users and items, rather than a comprehensive representation of what users like and dislike item-wise. In such an instance, a value of one, or any non-zero value, in the ratings matrix may indicate that the user had a preference for an item, and a value of zero may indicate that the preference of the user for the item is unknown to the recommendation system 130.

However, it is appreciated that in other embodiments, the ratings have different ranges and scales as described above. Since the number of users and items may be significantly large, and ratings may be unknown for many users and items, the rating matrix database 430 is, in general, a high-dimensional sparse matrix. Though described herein as a matrix, the actual structural configuration of the ratings matrix database 430 may vary in different embodiments to alternatively describe the preference information. As an example, user preference information may instead be stored for each user as a set of preference values for specified items. These various alternative representations of preference information may be similarly used for the analysis and preference prediction described herein.

From the rating matrix 430, the training module 410 learns parameters to represent items and users in forming predictions of user ratings. In particular, the training module 410 may generate a depopularized matrix 435, latent representations 450, and projected item weights 460 for use in predicting additional content items for users. Specifically, the training module 410 obtains latent user and item representations that discriminate between observed interactions and unobserved preferences sampled from a noise distribution in the ratings matrix R. The latent user and item representations can be used to generate recommendations.

In one embodiment, the training module 410 determines the latent user and item representations by increasing the following likelihood function for each user i:

$${argmax}_{{u}_{i} , V} = {\sum }_{j} R ( i , j ) \cdot [ log p ( R ( i , j ) = 1 \vert i , j ) + log 1 - p ( R ( i , {j}^{′} ) = 1 \vert i , {j}^{″} ) ] = {argmax}_{{u}_{i} , V} {\sum }_{j} R ( i , j ) \cdot [ log p ( R ( i , j ) = 1 \vert i , j ) + log p ( R ( i , {j}^{′} ) = 0 \vert i , {j}^{′} ) ] \qquad ( 1 )$$

where uᵢ is the latent user representation for user i, V is the matrix of latent item representations for items j=1, 2, . . . , n. R(i,j) denotes the 0 or 1 rating of user i for item j in the ratings matrix, and p(R(i,j)=1|i, j) denotes the estimated prediction of user i for item j generated by combining an estimated latent user representation uᵢ for user i with an estimated latent user representation vⱼ for item j. A higher value for the prediction may indicate a higher likelihood that user i will interact with item j. In one instance, the prediction p(R(i,j)=1|i, j) is given by the logistic sigmoid function:

$$p ( R ( i , {j}^{′} ) = 1 \vert i , j ) = σ ( {u}_{i}^{T} {v}_{j} ) = \frac{1}{1 + {e}^{{u}_{i}^{T} {v}_{j}}} . \qquad ( 2 )$$

Moreover, item j′ denotes a sampled “noise” item with an unknown preference in the ratings matrix R sampled according to a noise distribution q(j′). In one instance, the noise distribution q(j′) for item j′ is given by a popularity-based noise distribution:

$$q ( {j}^{′} ) = \frac{\vert R ( : , {j}^{′} ) \vert}{{\sum }_{k = 1}^{n} \vert R ( : , k ) \vert} \qquad ( 3 )$$

where |R(:,j′)| denotes the number of non-zero elements or interactions in the ratings matrix R for item j′. Based on the noise distribution in equation (3), the likelihood of sampling item j′ is proportional to the number of interactions or preferences for item j′, and thus, popular items have a higher likelihood of being sampled from the popularity-based noise distribution.

In one embodiment, the training module 410 may obtain the latent user and item representations by increasing the likelihood in equation (3) by taking the expectation with respect to the noise distribution q(j′), and summing over users i=1, 2, . . . m:

$${argmax}_{U , V} {\sum }_{j} R ( i , j ) \cdot [ log p ( R ( i , j ) = 1 \vert i , j ) + {E}_{q ( {j}^{′} )} [ log 1 - p ( R ( i , {j}^{′} ) = 1 \vert i , {j}^{″} ) ] ] \qquad ( 4 )$$

where U is the matrix of latent user representations. Thus, by increasing the likelihood function shown, for example, in equations (1) or (4), the latent representations are modeled such that estimated predictions generated by combining the latent user and item representations for known preferences are increased, while estimated predictions for unknown preferences sampled from the noise distribution q(j′) are decreased.

When applying the noise distribution in equation (3), the likelihood in equation (4) is increased or maximized with respect to the dot product of latent representations for user i and item j d_{i,j}=uᵢ^{T}vⱼ when:

$$\begin{matrix}{d}_{i , j}^{*} = log \frac{{\sum }_{k = 1}^{n} \vert R ( : , k ) \vert}{\vert R ( : , j ) \vert} , & ∀ R ( i , j ) = 1 \\ {d}_{i , j}^{*} = 0 , & ∀ R ( i , j ) = 0.\end{matrix} \qquad ( 5 )$$

The latent user and item representations that increase the likelihood in equation (4) can be obtained from a depopularized matrix D that has the same shape as the ratings matrix R, but has ratings modified to account for rating frequency of items. In particular, the depopularized matrix D is a matrix in which ratings of zero in the ratings matrix R remain zero, while ratings of one are replaced with a scaled value inverse to the number of users who interacted with the item. The scaled ratings of the depopularized matrix D may represent the “optimal” or desired inner product of user and item representations that account for popularity.

In another embodiment, when the uncertainty on the popularity of an item is high, the elements of the depopularized matrix D may be modified such that a hyperparameter β is introduced into the denominator of equation (5) to alleviate the effect of popularity uncertainty. Specifically, element d_{i,j} in the depopularized matrix D for a non-zero rating may be given by:

$${d}_{i , j}^{*} = log \frac{{\sum }_{k = 1}^{n} \vert R ( : , k ) \vert}{β \cdot \vert R ( : , j ) \vert} , ∀ R ( i , j ) = 1.$$

Thus, given a ratings matrix R for a set of users and items received from the preference management module 400, the training module 410 generates the depopularized matrix D by scaling the ratings in the ratings matrix R by decreasing a rating for a user and an item based on the popularity of the item, or in other words, the number of users who interacted with the item. Or said another way, the depopularized matrix D have values that reduce as the number of ratings for the item increase. In this way, although highly popular items may appear more often, these popular items may have a lower value in the depopularized matrix D, preventing them from overly affecting the subsequent representation. The depopularized matrix D may be stored in depopularized matrix store 435.

While a popularity-based noise distribution in the form of equation (3) was used to infer the depopularized matrix D in the example described above, it is appreciated that in other embodiments, different types of popularity-based noise distributions can be applied to determine desired values of the depopularized matrix D that increase the likelihood functions shown in equations (1) through (4).

Given a ratings matrix, the training module 410 obtains latent user representations uᵢ, i=1, 2, . . . , m and latent item representations vⱼ, j=1, 2, . . . , n from the depopularized matrix D. In particular, each user may be represented by a representation as a latent vector having a length k corresponding to k dimensions of the latent space, and each item may also be represented by a representation as a latent vector having a length k. However, it is appreciated that in other embodiments, latent user and item representations may have different dimensionality from one another. The latent vectors may also be referred to as embeddings. These are termed “latent” vectors because the values in the latent vectors are determined based on the relationships between the data, and each position in the vector may have no inherent semantic meaning to a human, but instead represents the relationships within the ranking data in the depopularized matrix 235.

In one embodiment, the depopularized matrix D is decomposed using singular value decomposition, and is represented by:

D=U_{D}Σ_{D}V_{D} (6)

where U_{D}, Σ_{D}, and V_{D} are factorized matrices. The latent user and item representations are given by:

U*≈U_{D}Σ_{D}^{1/2}

V*≈V_{D}Σ_{D}^{1/2}, (7)

where the i^{th} row in U* is a latent user representation of user i, and the j^{th} column in V* is a latent item representation of item j. These latent representations may be stored in latent representation store 440, and may be associated with k dimensions.

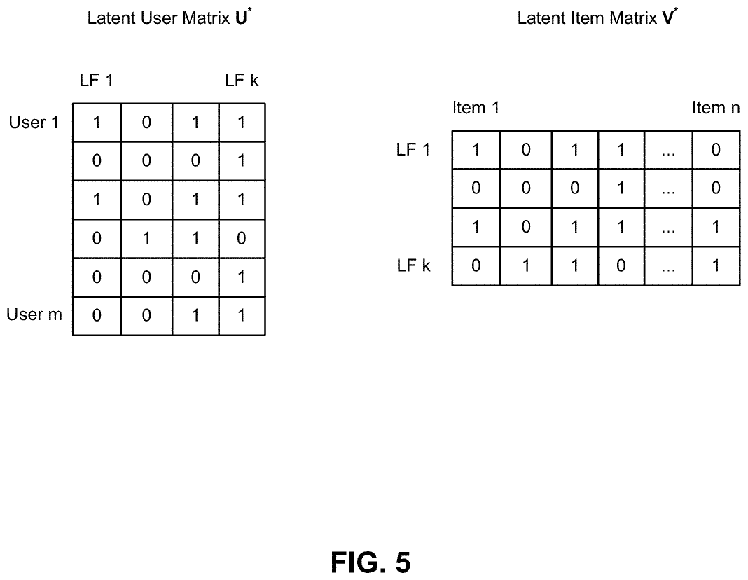

FIG. 5 illustrates an example latent user representation matrix U* and an example latent item representation matrix V* obtained from the depopularized matrix in FIG. 3. In the example shown in FIG. 5, the latent representations have a dimensionality of k=4. Specifically, each row in the latent user representation matrix U* is a latent user representation uᵢ for a corresponding user i with four elements corresponding to the dimensionality of the latent space. Similarly, each column in the in the latent item representation matrix V* is a latent item representation vⱼ for a corresponding item j with four elements.

In another implementation, the depopularized matrix D is decomposed into the factorized matrices that are “truncated” versions, in which U_{D}, Σ_{D}, and V_{D} correspond to portions of the factorized matrices with the highest singular values. In this example, Σ_{D} or is a diagonal latent weight matrix that represents the importance of the latent values in U_{D}, and V_{D}. The truncated representation of the depopularized matrix is advantageous when the dimensionality of the depopularized matrix D is significantly high, and the users and items have to be represented in a compressed format for improving computational efficiency.

In one embodiment, the training module 410 also trains a set of projected weights for each item that can be combined with dynamic user representations to generate recommendations for the online system 110. The dynamic user representation qᵢ for a user i can be combined with the set of projected item weights wⱼ to generate a prediction for user i for item j. In particular, the training module 140 generates the dynamic user representation qᵢ for user i by combining (e.g., averaging) the latent item representations of items the user has interacted with, and thus, is also a k-dimensional vector in the latent space. Returning to the example shown in FIGS. 3 and 5, the dynamic user representation q₁ of user 1 can be generated by combining the latent item representations v₁, v₃, v₄ for items 1, 3, 4 (in first, third, and fourth columns of V*) that the user had preferences for. When the ratings matrix R is a Boolean matrix, the dynamic user representation is the sum of the latent item representations.

The set of projected item weights wⱼ for item j is a k-dimensional vector of weights that can be combined with the dynamic user representation qᵢ, in which each element corresponds to the importance of a corresponding latent feature in the latent space. Given the latent user and item representations and the dynamic user representations, the training module 410 determines the set of projected item weights by repeatedly reducing a loss function. In one instance, the loss function is given by:

$${argmin}_{w} {\sum }_{i , j} {( R ( i , j ) - {q}_{i} {w}_{j} )}^{2} + λ \cdot {‖ {w}_{j} ‖}_{2}^{2} \qquad ( 8 )$$

where the j^{th} column in W is a set of projected item weights of item j. Thus, the loss function in equation (8) indicates a difference between the actual rating R(i,j) for the user-item pair and an estimated prediction for the element that is generated by combining the dynamic user representation for the user qᵢ with an estimated set of projected item weights for the item wⱼ.

In another instance, the loss function accounts for different weightings of users and items in the loss function, and the loss function is given by:

$${argmin}_{w} {\sum }_{i , j} {c}_{i , j} \cdot {( R ( i , j ) - {q}_{i} {w}_{j} )}^{2} + λ \cdot {‖ {w}_{j} ‖}_{2}^{2} \qquad ( 9 )$$

where c_{i,j} denotes the weighting in the loss function for user i and item j. In one instance, the weighting c_{i,j} is given by:

c_{i,j}=1+α·R(i,j) (10)

where α is a hyperparameter that manipulates the weighting differential of positive and negative ratings in the ratings.

In one embodiment, the set of projected item weights are determined by reducing the loss function shown in equation (9) when the hyperparameter α is set to zero. In particular, the training module 410 iterates over users i=1, 2, . . . n to update the set of projected item weights by:

C^{j}←diag(1+α·R(:,j))

w^{j}←(Q^{T}C^{j}Q+λI)⁻¹Q^{T}C^{j}R(:,j), (11)

where the ith row of matrix Q is the dynamic user representation of user i, and C^{j} is a diagonal matrix with diagonal elements of equation (10). The resulting values for the set of projected item weights w^{j} may represent the “optimal” or desired values that reduce the loss function given by equation (9).

The prediction module 420 generates predictions for user-items with unknown preferences to predict whether users will prefer certain items over others, and provides recommendations of items to users of client devices 116. In one embodiment, the prediction module 420 generates a prediction for user i for item j by combining the latent user representation uᵢ and latent item representation vⱼ. When the ratings are Boolean values, a higher prediction indicates a higher likelihood that the user will have a preference for the item. In one instance, the latent user and item representations are combined through a dot product uᵢ·vⱼ of the two vectors. However, it is appreciated that in other embodiments, the latent user and item representations are combined through any appropriate operation.

In another embodiment, the prediction module 420 uses dynamic user representations to generate the recommendations. Specifically, the prediction module 420 generates a prediction for user i for item j by combining the dynamic user representation qᵢ and the set of learned projected item weights wⱼ. In this approach, users are represented according to the content items that the users rated, resolving the “cold start” problem by allowing a user representation to be dynamically modified as the user interacts with content items.

Based on the generated predictions, the prediction module 420 may identify, for each user, a subset of items that are associated with predicted likelihoods above a threshold amount or a threshold proportion among the set of items of the online system 110. For example, for a given user, the prediction module 420 may rank items with unknown preferences for the user according to their predicted likelihoods, and identify a subset of items that are within a threshold rank. The prediction module 420 may provide the subset of items to the client devices 116, such that users can be presented with recommendations for items that they are likely to interact with.

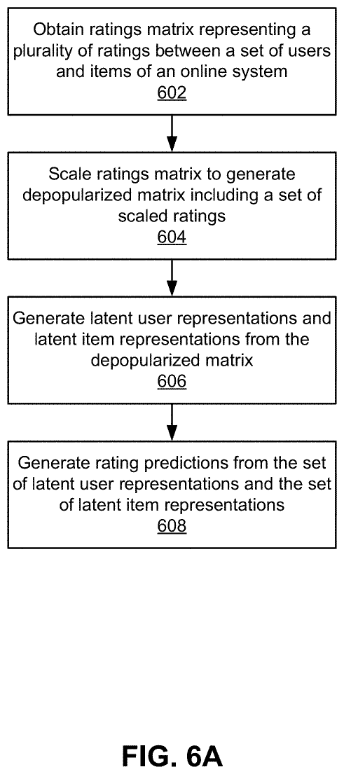

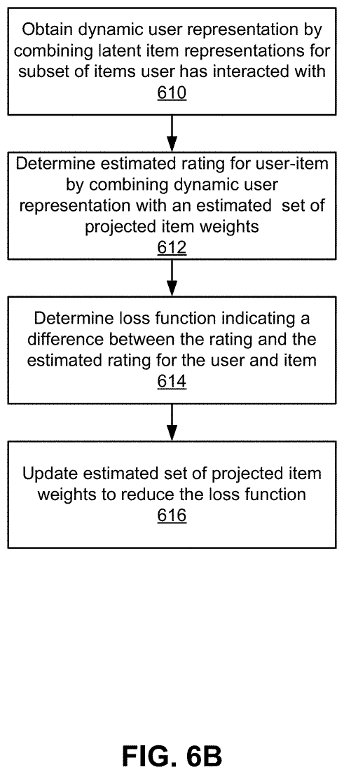

FIG. 6A illustrates a method of generating rating predictions for a set of users and a set of items of an online system, in accordance with an embodiment. The recommendation system 130 obtains 602 a ratings matrix representing a plurality of ratings between the set of users and the set of items. An entry in the ratings matrix for a user and an item may indicate whether the user interacted with the item. The recommendation system scales 604 the ratings matrix to generate a depopularized matrix including a set of scaled ratings. The ratings matrix is scaled by modifying a rating for a user and an item based on a number of users who interacted with the item. The recommendation system generates 606 a set of latent user representations and a set of latent item representations from the depopularized matrix. The latent user representation represents a user in the set of users in a latent space, and the latent item representation representing an item in the set of items in the latent space. The dimensionality of the latent space may be smaller than a number of users and items. The recommendation system generates 608 rating predictions for the set of users and the set of items from the set of latent user representations or the set of latent item representations.

FIG. 6B illustrates a method of training projected item weights from latent user and item representations, in accordance with an embodiment. For each user in the set of users, the recommendation system obtains 610 a dynamic user representation for the user. The dynamic user representation is obtained by combining a subset of latent item representations for a subset of items that the user has interacted with. The recommendation system combines 612 the dynamic user representation for the user and an estimated set of projected item weights for the item to determine an estimated rating for the user and the item. The recommendation system determines 614 a loss function indicating a difference between a rating in the ratings matrix for the user and the item, and the estimated rating for the user and the item. The recommendation system updates 616 the estimated set of projected item weights for the item to reduce the loss function until, for example, a predetermined criteria is reached.

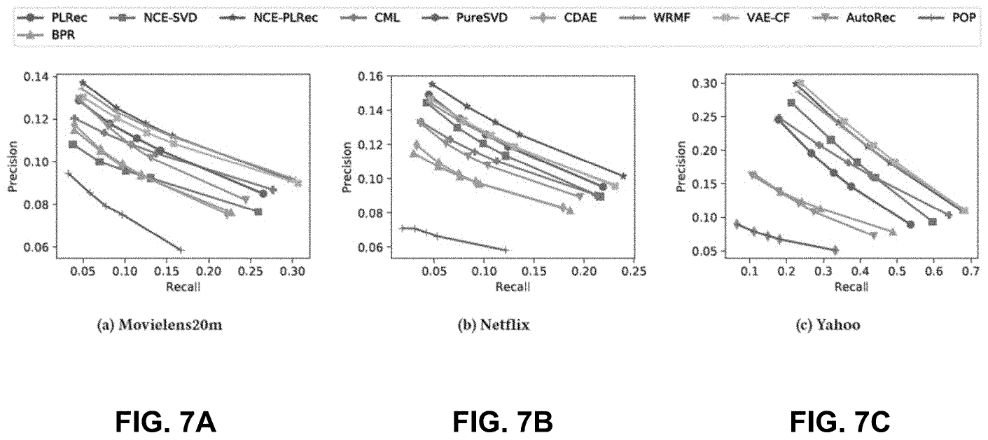

FIGS. 7A through 7C illustrate performance results of example recommendation models presented herein in comparison to other state-of-the-art models. Specifically, the results shown in FIGS. 7A through 7C train recommendation models as discussed herein and other models respectively on training datasets that are subsets of the Movielens-20M (“Movielens”) dataset, Netflix Prize (“Netflix”), and Yahoo R1 (“Yahoo”) datasets. The Movielens dataset contained 138,493 users, 27,278 items, and 12,195,566 non-zero ratings. The Netflix dataset contained 2,649,430 users, 17,771 items, and 56,919,190 non-zero ratings. The Yahoo dataset contained 1,948,882 users, 46,110 items, and 48,817,561 non-zero ratings.

The performance of each model is determined by applying the models on test data that is a subset of the same dataset that does not overlap with the training data, and predicting users will interact with items that are above a threshold likelihood. The actual preferences are compared with predicted preferences, and the proportion of ratings in the test data in which that have matching preferences are recorded. For each dataset, recall and precision are plotted to evaluate how well the models perform. A larger area under the curve may indicate that the model is good at generating accurate predictions.

FIG. 7A illustrates the recall and precision tradeoff curve of the Movielens dataset. FIG. 7B illustrates the recall and precision tradeoff curve of the Netflix dataset. FIG. 7C illustrates the recall and precision tradeoff curve of the Yahoo dataset. The “POP,” “PureSVD,” “WRMF,” “AutoRec,” “CDAE,” “VAE-CF,” “BPR,” “CML,” “PLRec,” are state-of-the art recommendation models. The “NCE-SVD” model is the recommendation model described herein, in which latent user and item representations are combined through a dot product to generate predictions. The “NCE-PLRec” model is the recommendation model described herein, in which dynamic user representations and the set of learned projected item weights are combined through a dot product to generate predictions.

As shown in FIGS. 7A-7B, the NCE-PLRec model outperforms all state-of-the-art models for the Movielens and Netflix datasets. As shown in FIG. 7C, the NCE-PLRec model performs strongly competitive with state-of-the-art VAE-CF deep learning model for the Yahoo dataset. Moreover, NCE-PLRec also shows substantial performance improvement compared to PLRec that does not sample unknown preferences from a popularity-based noise distribution, illustrating the advantages and benefits of using such a distribution as described herein. In general, the NCE-PLRec model spreads its recommendations over the popularity spectrum, and proves beneficial in terms of its overall ranking performance.

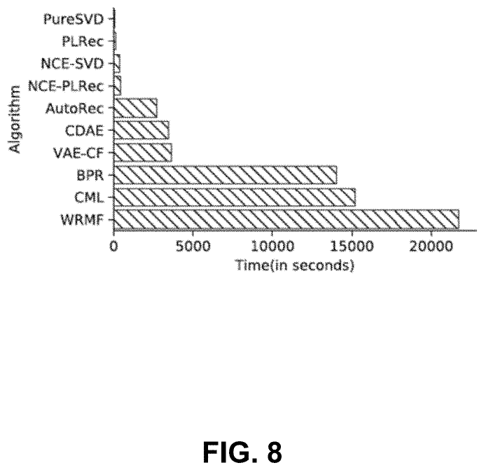

FIG. 8 illustrates the training time for the state-of-the-art model, NCE-SVD, and NCE-PLRec models as described above. As shown in FIG. 8, the NCE-SVD and NCE-PLRec models have a significant improvement in training efficiency compared to other state-of-the-art models with similar performance. Moreover, NCE-PLRec easily scale to the very large datasets evaluated herein.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a processor configured to execute instructions;
a computer-readable medium containing instructions for execution on the processor, the instructions causing the processor to perform steps of:
obtaining a ratings matrix representing a plurality of ratings between a set of users and a set of items, wherein an entry in the ratings matrix for a user and an item indicates whether the user interacted with the item;
scaling the ratings matrix to generate a depopularized matrix including a set of scaled ratings, wherein the ratings matrix is scaled by modifying a rating for a user and an item based on a number of users who interacted with the item;
generating a set of latent user representations and a set of latent item representations from the depopularized matrix, a latent user vector representing a user in the set of users in a latent space, and a latent item vector representing an item in the set of items in the latent space; and
generating the rating predictions for the set of users and the set of items from the set of latent user representations or the set of latent item representations.

2. The system of claim 1, wherein the entry in the ratings matrix for the user and the item is represented as a Boolean value, in which the entry is zero if a preference of the user for the item is unknown, or a non-zero value if the user interacted with the item.

3. The system of claim 1, wherein scaling the ratings matrix comprises instructions for multiplying the rating by a total number of interactions in the ratings matrix and an inverse of the number of users who interacted with the item.

4. The system of claim 1, wherein generating the rating predictions for the set of users and the set of items comprises instructions for combining the set of latent user representations and the set of latent item representations through a dot product.

5. The system of claim 1, wherein generating the rating predictions for the set of users and the set of items comprises instructions for:
for each user in the set of users, obtaining a dynamic user representation for the user, the dynamic user representation obtained by combining a subset of latent item representations for a subset of items that the user has interacted with, and
combing the dynamic user representation for the user with a set of projected item weights through a dot product.

6. The system of claim 1, wherein the instructions further comprise:
for each user in the set of users, obtaining a dynamic user representation for the user, the dynamic user representation obtained by combining a subset of latent item representations for a subset of items that the user has interacted with; and
determining a projected weight vector for an item by repeatedly performing, for each user in the set of users:
combining the dynamic user representation for the user and an estimated set of projected item weights for the item to determine an estimated rating for the user and the item,
determining a loss function indicating a difference between a rating in the ratings matrix for the user and the item, and the estimated rating for the user and the item, and
updating the estimated set of projected item weights for the item to reduce the loss function.

7. The system of claim 1, wherein a dimensionality of the set of latent user representations and the set of latent item representations is smaller than a number of the set of users and a number of the set of items.

8. A method for generating rating predictions for a set of users and a set of items of an online system, comprising:
obtaining a ratings matrix representing a plurality of ratings between the set of users and the set of items, wherein an entry in the ratings matrix for a user and an item indicates whether the user interacted with the item;
scaling the ratings matrix to generate a depopularized matrix including a set of scaled ratings, wherein the ratings matrix is scaled by modifying a rating for a user and an item based on a number of users who interacted with the item;
generating a set of latent user representations and a set of latent item representations from the depopularized matrix, a latent user representation representing a user in the set of users in a latent space, and a latent item representation representing an item in the set of items in the latent space; and
generating the rating predictions for the set of users and the set of items from the set of latent user representations or the set of latent item representations.

9. The method of claim 8, wherein the entry in the ratings matrix for the user and the item is represented as a Boolean value, in which the entry is zero if a preference of the user for the item is unknown, or a non-zero value if the user interacted with the item.

10. The method of claim 8, wherein scaling the ratings matrix comprises multiplying the rating by a total number of interactions in the ratings matrix and an inverse of the number of users who interacted with the item.

11. The method of claim 8, wherein generating the rating predictions for the set of users and the set of items comprises combining the set of latent user representations and the set of latent item representations through a dot product.

12. The method of claim 8, wherein generating the rating predictions for the set of users and the set of items comprises:
for each user in the set of users, obtaining a dynamic user representation for the user, the dynamic user representation obtained by combining a subset of latent item representations for a subset of items that the user has interacted with, and
combing the dynamic user representation for the user with a set of projected item weights through a dot product.

13. The method of claim 8, further comprising:
for each user in the set of users, obtaining a dynamic user representation for the user, the dynamic user representation obtained by combining a subset of latent item representations for a subset of items that the user has interacted with; and
determining a set of projected item weights for an item by repeatedly performing, for each user in the set of users:
combining the dynamic user representation for the user and an estimated set of projected item weights for the item to determine an estimated rating for the user and the item,
determining a loss function indicating a difference between a rating in the ratings matrix for the user and the item, and the estimated rating for the user and the item, and
updating the estimated set of projected item weights for the item to reduce the loss function.

14. The method of claim 8, wherein a dimensionality of the set of latent user representations and the set of latent item representations is smaller than a number of the set of users and a number of the set of items.

15. A non-transitory computer-readable medium containing instructions for execution on a processor, the instructions comprising:
obtaining a ratings matrix representing a plurality of ratings between a set of users and a set of items, wherein an entry in the ratings matrix for a user and an item indicates whether the user interacted with the item;
scaling the ratings matrix to generate a depopularized matrix including a set of scaled ratings, wherein the ratings matrix is scaled by modifying a rating for a user and an item based on a number of users who interacted with the item;
generating a set of latent user representations and a set of latent item representations from the depopularized matrix, a latent user representation representing a user in the set of users in a latent space, and a latent item representation representing an item in the set of items in the latent space; and
generating the rating predictions for the set of users and the set of items from the set of latent user representations or the set of latent item representations.

16. The non-transitory computer-readable medium of claim 15, wherein the entry in the ratings matrix for the user and the item is represented as a Boolean value, in which the entry is zero if a preference of the user for the item is unknown, or a non-zero value if the user interacted with the item.

17. The non-transitory computer-readable medium of claim 15, wherein scaling the ratings matrix comprises instructions for multiplying the rating by a total number of interactions in the ratings matrix and an inverse of the number of users who interacted with the item.

18. The non-transitory computer-readable medium of claim 15, wherein generating the rating predictions for the set of users and the set of items comprises instructions for combining the set of latent user representations and the set of latent item representations through a dot product.

19. The non-transitory computer-readable medium of claim 15, wherein generating the rating predictions for the set of users and the set of items comprises instructions for:
for each user in the set of users, obtaining a dynamic user representation for the user, the dynamic user representation obtained by combining a subset of latent item representations for a subset of items that the user has interacted with, and
combing the dynamic user representation for the user with a set of projected item weights through a dot product.

20. The non-transitory computer-readable medium of claim 15, wherein the instructions further comprise:
for each user in the set of users, obtaining a dynamic user representation for the user, the dynamic user representation obtained by combining a subset of latent item representations for a subset of items that the user has interacted with; and
determining a set of projected item weights for an item by repeatedly performing, for each user in the set of users:
combining the dynamic user representation for the user and an estimated set of projected item weights for the item to determine an estimated rating for the user and the item,
determining a loss function indicating a difference between a rating in the ratings matrix for the user and the item, and the estimated rating for the user and the item, and
updating the estimated set of projected item weights for the item to reduce the loss function.
